(19) United States
(12) Patent Application Publication
(10) Pub. No.: US 2009/0119165 A1
(43) Pub. Date: May 7, 2009

(54) Custom personalized online advertising

(76) Inventor: James Cotgreave, Smithtown, NY (US)

Correspondence Address: Thomas M. Galgano, 20 W. Park Avenue, Suite 204, Long Beach, NY, 11561, US

(21) Appl. No.: 11/982,632

(22) Filed: Nov. 2, 2007

(51) Int. Cl. G06Q 30/00

(52) U.S. Cl. 705/14

(57) ABSTRACT

Custom personalized advertisements contain variables which identify types of personal information. When an advertisement loads on a user's display, the content provider identifies the user and provides the personal information identified by the variables for this particular user. The variables in the advertisement are then replaced with the personal information before the advertisement is displayed. The substitution of information for variables can occur at the content provider's servers or the information can be transmitted to a remote advertisement server where it is inserted into the advertisement before sending the custom personalized advertisement to the user's browser. If the information is sent to the advertising server it can be cached so that in the future only the user ID needs to be sent to the server to create a personalized advertisement for this particular user. In the case of caching, the information can be kept up to date by including a last modified date and time in the database of user information.

The complete disclosures of my prior applications SYSTEM AND METHOD FOR CONNECTING INDIVIDUALS IN A SOCIAL NETWORKING ENVIRONMENT BASED ON FACIAL RECOGNITION SOFTWARE, Ser. No. 11/899,220 filed Sep. 5, 2007 and SYSTEMS AND METHODS FOR FACIAL RECOGNITION, Ser. No. 11/901,830, filed Sep. 19, 2007 are hereby incorporated herein by reference.

### BACKGROUND OF THE INVENTION

1. Field of the Invention

This invention relates broadly to online advertising. More particularly, this invention relates to creating and displaying online advertisements that are customized and personalized for the persons viewing them.

2. State of the Art

Online advertising typically requires the participation of four entities: a content provider, users, advertisers, and an advertising broker. Content providers are companies or individuals who maintain websites containing original content or web portals that link to other sites that provide content. Users are individuals who visit the sites and portals. Advertisers are merchants who pay content providers to display advertisements on their site. Advertising brokers are companies or individuals who help advertisers distribute advertisements to content providers.

There are presently three major types of advertisements that are displayed on web pages: text, image banners, and animations or videos made with Adobe Flash or Microsoft Silverlight. Prior art FIG. 9 shows a typical web advertisement having text and graphics. The text is often not really text but is a graphical representation of text which cannot be edited or manipulated with a text editor. State of the art online advertising methods allow for personalization of advertisements in some limited ways. Websites such as social networking sites allow users to create a list of preferences and/or allow users to become members of special interest groups. Current techniques allow for targeted advertising based on these preferences or special interests. For example, if a user joins a special interest group of sports car enthusiasts, they will receive advertising for sports cars and sporty cars but not for minivans. Similarly, if a user joins a group of Mets fans, they will receive advertising for baseball and New York. Existing software also allows advertisers to identify a user's zip code based on IP (internet protocol) address. This technique is widely used in advertisements for dating services, e.g. “Find a mate in GREENWICH, CT” or “Find a mate in SMITHTOWN, NY”.

### SUMMARY OF THE INVENTION

The present invention collects personal data about a user such as the user's name, city, country, age, gender, and, preferably, their photograph and uses that personal information to create custom personalized advertisements in real time as a user loads a web page. The invention can be used with any content provider that keeps a database of personal information about its users. The invention is particularly well suited for social networking sites and especially well suited to sites where users upload photos of themselves and their friends.

According to the invention, advertisers or advertising brokers create advertisements which contain variables which identify types of personal information. When an advertisement loads on a user's display, the content provider identifies the user and provides the personal information identified by the variables for this particular user. The variables in the advertisement are then replaced with the personal information before the advertisement is displayed. The substitution of information for variables can occur at the content providers servers or the information can be transmitted to a remote advertisement server where it is inserted into the advertisement before sending the custom personalized advertisement to the users computer or web browsing device. In the case where the information is sent to a remote advertisement server it can be cached so that in the future only the user ID needs to be sent to the server to create a personalized advertisement for this particular user. In the case of caching, the information can be kept up to date by including a last modified date and time in the database of user information.

Additional objects and advantages of the invention will become apparent to those skilled in the art upon reference to the detailed description taken in conjunction with the provided figures.

### BRIEF DESCRIPTION OF THE DRAWINGS

FIG. 1 is a simplified flow chart illustrating how an advertisement is created according to the invention;

FIG. 2 is a simplified flow chart illustrating how an advertisement is displayed according to the invention;

FIG. 3 is an example of a web advertisement according to the invention which has been customized with text that is personal to a particular user;

FIG. 4 is an illustration of how a user photograph is cropped according to the previously incorporated applications;

FIG. 5 is an illustration of how a user photograph together with text that is personal to the user are incorporated into a web advertisement;

FIG. 6 is another illustration of how a user photograph together with text that is personal to the user are incorporated into a web advertisement;

FIG. 7 is a simplified schematic illustration of a web advertisement personalization tool according to the invention with an advertisement yet to be personalized;

FIG. 8 is a view similar to FIG. 7, but showing how personalized text and graphics variables have been added to the advertisement; and

FIG. 9 is an illustration of a prior art web advertisement.

### DETAILED DESCRIPTION

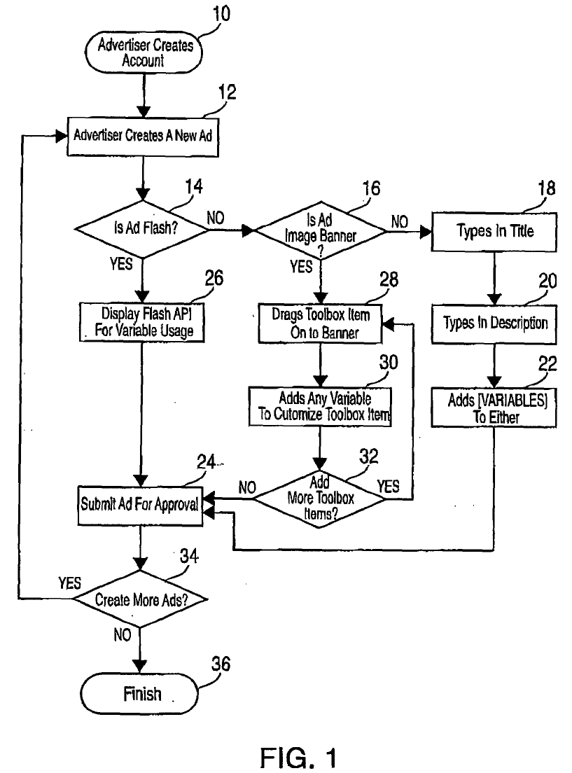

Turning now to FIG. 1, according to an embodiment of a method according to the invention, an advertiser creates an account at 10 and chooses to create a new advertisement at 12. At 14 and 16, it is determined whether the advertisement is Flash, an image banner, or a simple text advertisement. If it is text only, the advertiser types in the title at 18 and the description at 20. At 22, variables can then be added to either the title, the description or both. Table 1, below, lists an example of the types of data maintained by a content provider about users, some of which are variables which can be used to create custom personalized web advertisements. The created advertisement is thus a template containing variables which will be replaced with personal data just before the advertisement is displayed.

TABLE 1

| Database Field | Data Type | Examples |
|---|---|---|
| userID | Numeric | 1, 2, 3, 4 . . . |
| username | String | Bill76, Suzy12, bigTom |
| first_name | String | Bill, Susan |
| last_name | String | Smith, Jones |
| email_address | String | bill@domain.com |
| address | String | 1 Main Street |
| city | String | Manhattan |
| state | String | NY, California |
| zip code | String | 10002, 90210 |
| gender | String | M, Male, male, F, Female, female |
| age | Numeric | 15, 25, 35 |
| Photo_location | String | http://www.CPDomain.com/imagename.jpg |
| date_modified | Date | 10/16/2007 |

An exemplary text advertisement template created according to the invention reads “Hello <first_name>! Would you like to meet a mate in <city>, <state>?” Using the <gender> field, the Word “mate” in the text advertisement can be changed to “man” or “woman”. Using the <age> field, advertisements can be targeted to particular age groups. After the text advertisement with inserted variables is completed at 22 in FIG. 1, it is sent at 24 to the content provider or advertising broker for approval. The approval process can be omitted in cases where the advertisement creator is a trusted long standing customer.

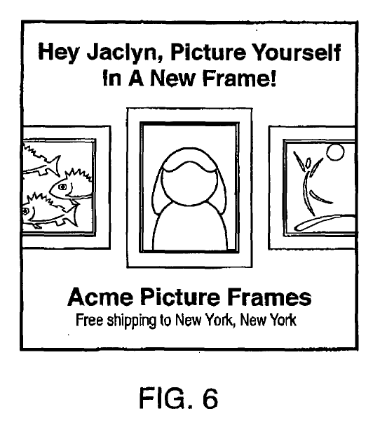

If it were determined at 14 that the advertisement is to be created in Flash or Silverlight, the invention provides a simple API (application programming interface) which allows the inclusion of variables. The API contains a list of variables, e.g. those listed in Table 1, and instructions regarding where to place the variables, e.g. in the first frame of a Flash presentation. FIGS. 5 and 6 illustrate advertisements which can result from including variables in a Flash presentation. They include the user's name and location as well as the photo of the user as part of the advertisement. Though not shown in FIGS. 5 and 6, advertisements created in Flash can also have one or more kinetic elements such as animation or video.

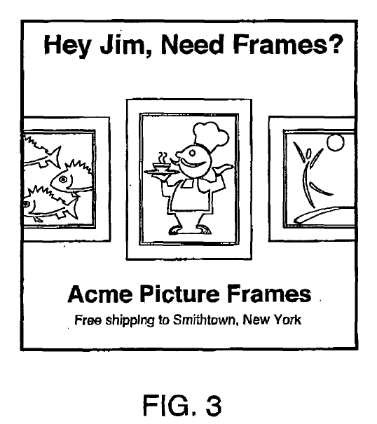

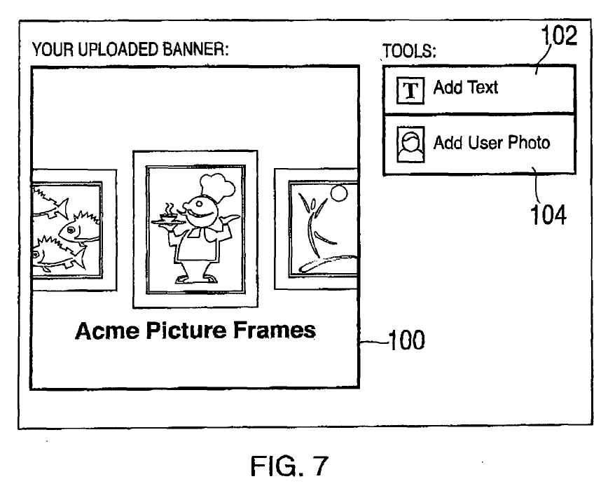

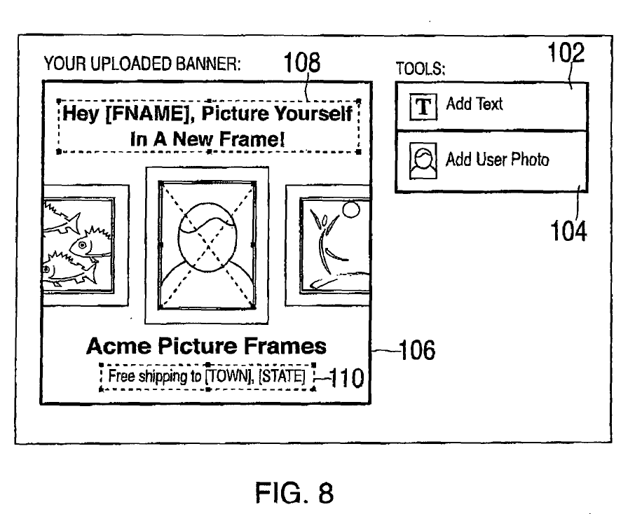

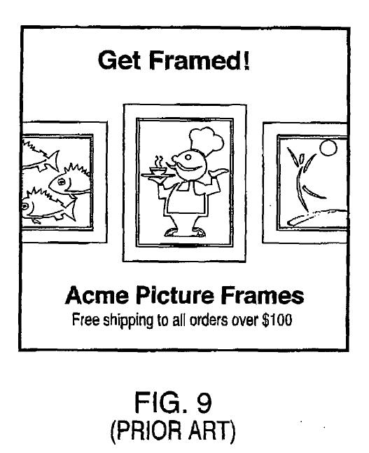

If it is determined at 16 in FIG. 1 that the advertisement is to be an image banner, the user (advertiser) interface shown in FIGS. 7 and 8 may be used. The advertiser drags (28 in FIG. 1) a tool onto the banner to prepare it for custom personalization. FIG. 7 shows a banner advertisement 100 before it is prepared for custom personalization. A text too 102 is shown as well as a tool 104 to add the users photo. FIG. 8 shows the prepared advertisement template 106 with two text fields 108, 110, each having personal text variables (added at 30 in FIG. 1). The text field 108 includes the variable for the users first name. The text field 110 includes the variables for the user's city (town) and state. The users photo 112 is incorporated into the advertisement. An advertisement created in this manner will look like the advertisement shown in FIG. 5 when viewed by Jim and will look like the advertisement shown in FIG. 6 when viewed by Jaclyn. If the user photo tool were not used or if Jim had not uploaded a photo, the advertisement would look like the advertisement shown in FIG. 3 when viewed by Jim. As shown in FIG. 1, at 32, the advertiser may choose to add more text, variables and photos before sending the advertisement for approval (24 in FIG. 1).

It is also possible according to the invention to use other photos to create custom personalized advertisements. For example, if the content provider has stored photos of the user's friends together with their first names, an advertisement can be created using those photos as well. An example of such an advertisement is a travel advertisement which shows the user and the user's friends at a travel destination with a phrase like. “Hey Jim, why don't you and Laura take a trip to Vegas this weekend”.

FIG. 1 shows the basic workflow for preparing templates for custom personalized web advertisements. Advertisement templates are sent to the content provider or advertising broker for approval at 24 unless the advertiser is a trusted customer. At 34 the advertiser can choose to create another advertisement by returning to 12 or may choose to quit at 36.

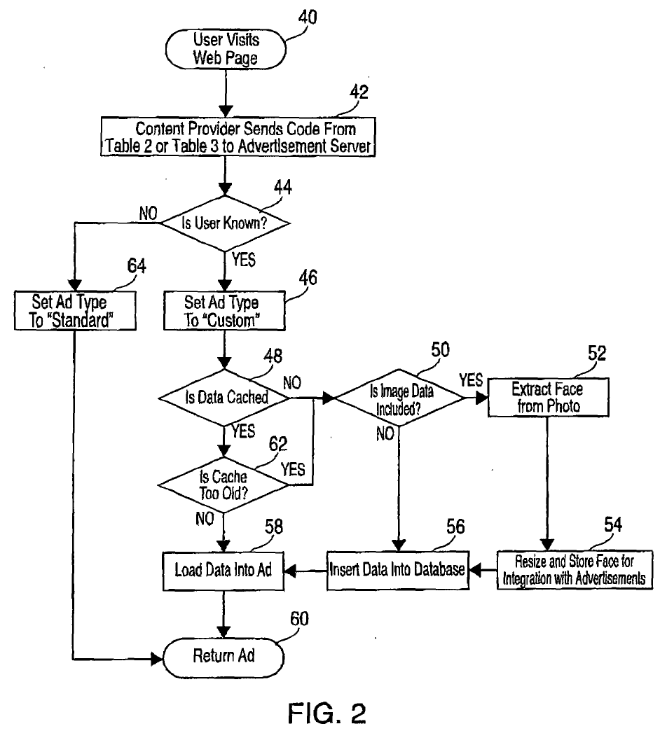

FIG. 2 illustrates the process of displaying a custom personalized web advertisement once the template has been prepared. A user visits a website (types in a URL or selects a bookmark) at 40. When a user visits a website, the website identifies the user's IP address if the user is not behind a fire wall or a network address translating router. More reliably, the website identifies the user via a cookie, a small text file created at the time the user registers at a website. The cookie is stored on the user's computer and is transmitted to the website whenever the user returns to the website. Alternatively, the user logs into the website and is identified that way. Whether or not the user is known to the website, the content provider sends a script to the advertisement server at 42.

Table 2, below, shows an exemplary script for putting personal variables into an advertisement template. The script is assembled at the content provider and sent to the advertisement server (which could be the same server as the content provider server) before the advertisement is sent to the user's browser. The script in Table 2 assumes that the user is known to the content provider, i.e. is logged in to the content provider's website or identified via cookie or IP address.

TABLE 2

| | |
|---|---|
| 1 | <script language=”javascript”> |
| 2 | IFT_publisherID=”123456789”; |
| 3 | IFT_width=”468”; |
| 4 | IFT_height=”60”; |
| 5 | IFT_image=”http://www.CPDomain.com/imagename.jpg”; |
| 6 | IFT_userID=”555”; |
| 7 | IFT_cacheDate=”10/1/2007 12:00pm”; |
| 8 | IFT_firstName=”James”; |
| 9 | IFT_gender=”Male”; |
| 10 | IFT_postalCode=”10002”; |
| 11 | </script> |
| 12 | <script type=″text/javascript″ |
| 13 | src=″http://ads.industryForward.com/showAds.js″> |
| 14 | </script> |

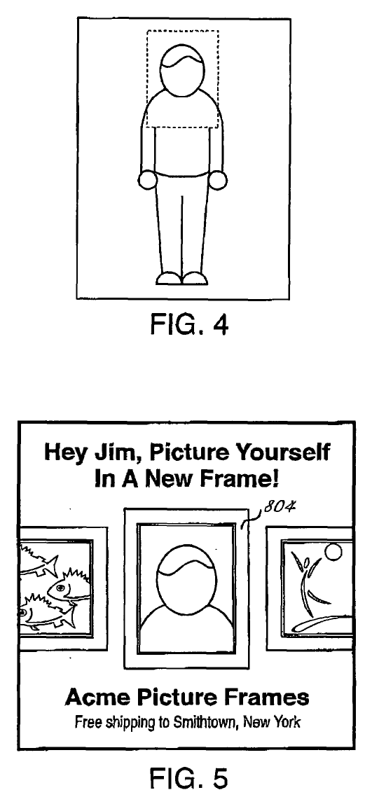

Line 1 declares that the code is based in JavaScript. Line 2 sets the variable publisherID to a unique number given to the content provider by an advertising broker. The prefix “IFT_” is prepended to variables to assure that they are unique. Lines 3 and 4 set the size of the advertisement. Line 5 sets the location of a photo of the user. Line 6 sets the variable userID to a value provided by the content provider indicating the identity of the user. Line 7 sets the date and time that this user last updated his information on the content providers website. Lines 8-10 set personal information about this user. Line 11 indicates that the script for setting variable values is finished. Line 12 indicates the start of a new script. Line 13 indicates the location, of the java script which contains the advertisement. Line 14 ends the second script. The photo of the user is preferably contains the users face as explained in the previously incorporated applications and as illustrated schematically in FIG. 4.

If the user is unknown to the content provider, the script shown in Table 3 is sent to the advertisement server.

TABLE 3

| | |
|---|---|
| 1 | <script language=”javascript”> |
| 2 | IFT_publisherID=”456456465”; |
| 3 | IFT_width=”468”; |
| 4 | IFT_height=”60”; |
| 5 | IFT_userID=””; |
| 6 | IFT_image=””; |
| 7 | IFT_cacheDate=””; |
| 8 | IFT_firstName=””; |
| 9 | IFT_gender=””; |
| 10 | IFT_postalCode=””; |
| 11 | </script> |
| 12 | <script type=″text/javascript″ |
| 13 | src=″http://ads.industryForward.com/showAds.js″> |
| 14 | </script> |

Tables 2 and 3 may also include style information regarding fonts and colors for example so that the advertisement will blend better with the web page on which it is displayed.

If it is determined at 44 that the user is known, the flag “Ad Type” is set to custom at 46. At 48, it is determined whether the data (i.e. images, since string and numeric data are included in the script) for this user has been cached at the advertisement server. If it has not, it is then determined at 50 whether a photo of the user is available from the content provider, i.e. whether the script contained the line “IFT_image=“http://www.CPDomain.com/imagename.jpg””. If there is no image available only the text data is inserted into the cache database at 56. If a photo is available, it is also inserted into the cache database. At 58, the custom personalized web advertisement is created by loading the data from the script into the variables in the advertisement template. The advertisement is then sent to the users browser at 60 with the personal information inserted into the advertisement where the variables were placed in the template.

If it is determined at 50 that an image is available at the content provider, that image is loaded using the address provided in the script. If necessary, the face is extracted from the image at 52 as described in the previously incorporated applications and as illustrated schematically in FIG. 4. At 54 the face image is resized to fit in the advertisement. The resized face image together with the numeric and text information from the script is cached at 56 and loaded into the advertisement at 58. The advertisement is then sent to the user's browser at 60 with the personal information, including image, inserted into the advertisement where the variables were placed in the template.

If it were determined at 48 that the personal data for this user has already been cached, it is then determined at 62 (by comparing the date_modified date in the cached record with the date_modified date in the script) whether the cached data is out of date. If the cached data is current, it is used and the advertisement loads faster on the user's screen. Since many websites do not require registration, it may be determined at 44 that the user is unknown, in which case the flag “Ad Type” is set to standard at 64 and a non-personalized advertisement is displayed at 60.

There have been described and illustrated herein several embodiments of methods for creating and presenting custom personalized web advertisements. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. A method for creating custom personalized web advertisements for a website user, comprising:
creating an advertisement template containing variables which identify types of personal information;
maintaining a database of website users, said database including personal information about said users;
substituting personal information from said database for said variables in said template thereby creating a custom personalized advertisement for the website user; and
transmitting the custom personalized advertisement to the website user.

2. A method according to claim 1, further comprising:
prior to said substituting, identifying the website user and retrieving personal information about the website user from the database based on said identifying.

3. A method according to claim 2, wherein:
said personal information includes a photograph of the website user.

4. A method according to claim 3, wherein:
said maintaining a database of website users is performed by a content provider.

5. A method according to claim 4, further comprising:
prior to said substituting, transmitting said personal information to an advertisement server; and
caching said personal information at said advertisement server.

6. A data structure embodied on a computer readable medium, comprising:
data representative of a web advertisement including text; and
a plurality of variables interspersed within said text, said variables each identifying a type of personal information.

7. A data structure according to claim 6, wherein:
said data representative of a web advertisement includes graphics.

8. A data structure according to claim 7, wherein:
said type of personal information includes graphical information;

9. A data structure according to claim 8, wherein:
said graphical information includes a photograph.

10. A data structure according to claim 9, wherein:
said data representative of a web advertisement includes animation.

11. A data structure according to claim 9, wherein:
said data representative of a web advertisement includes video.
